(19) United States
(12) Patent Application Publication
(10) Pub. No.: US 2015/0016045 A1
(43) Pub. Date: Jan. 15, 2015

(54) MEMORY ASSEMBLY WITH PROCESSOR MATCHING PIN-OUT

(71) Applicant: Integrated Silicon Solution, Inc., Milpitas, CA (US)

(72) Inventor: Lyn R. Zastrow, Coppell, TX (US)

(21) Appl. No.: 13/940,036

(22) Filed: Jul. 11, 2013

(51) Int. Cl. G06F 1/18

(52) U.S. Cl. CPC G06F 1/183
USPC 361/679.32

(57) ABSTRACT

A memory device includes one or more memory semiconductor chips housed in a surface-mount semiconductor package and formed on a package substrate. The package substrate includes a two-dimensional array of package leads for connecting signals of the one or more memory semiconductor chips to an external system. The memory assembly has a package pin-out being a mirror image of a memory interface pin-out of a processor. In other embodiments, a circuit module includes a printed circuit board, a processor mounted on a first side of the printed circuit board and a memory assembly mounted on a second, opposite side of the printed circuit board. The memory assembly has a memory assembly pin-out that is a mirror image of the memory interface pin-out of the processor and the memory assembly is positioned in direct alignment with the memory interface pin-out of the processor.

### BACKGROUND OF THE INVENTION

Most ball grid array (BGA) packaged memory devices in the market today use a JEDEC standard pin-out. In the case of DRAM devices, the standard JEDEC standard pin-out applies to all of the technologies in the market. For example, standard JEDEC standard pin-out are used for Extended Data Out (EDO), FP (Fast Page), SDRAM (Synchronous DRAM), DDR (Double Data Rate), DDR2 (second generation Double Data Rate), DDR3 and other DRAM devices. Having memory devices that follows a standard pin-out has its advantages. For instance, generic models can be used to place parts on boards and standardized test equipment can be manufactured. Also, economies of scale for standardized devices can be realized to keep the manufacturing cost low.

While there is a JEDEC standard for the pin-out of memory devices, there is no standard for the pin-out of processors or graphics controllers that use external memory. Hence, every design that uses a processor or graphics controller and a memory must have unique routing on the printed circuit (PC) board to connect the processor to the memory. As the processors get more complicated and faster, and as the memory interfaces also get more complicated and faster, there are many challenges involved in the routing of the signals between these components. For instance, the trace length and via counts for each of the address lines must be balanced, that is, the address lines on the PC board must be equal in length and have a common number of vias for each line. The same applies to the data lines as well. In addition, the control lines need to be carefully set up so that the timing of the signals with regards to the address and data lines is not distorted. In order to maintain the signal integrity, a multi-layer PC board is often required.

### BRIEF DESCRIPTION OF THE DRAWINGS

Various embodiments of the invention are disclosed in the following detailed description and the accompanying drawings.

FIG. 1 is a perspective view of a conventional circuit module including a processor connected to one or more discrete memory devices.

FIG. 2(a) illustrates a circuit module constructed using a memory assembly with processor-specific package pin-out according to one embodiment of the present invention.

FIGS. 2(b) and 2(c) are front-side view and back-side view, respectively, of the circuit module of FIG. 2(a).

FIG. 3 is a cross-sectional view of the circuit module of FIGS. 2(a)-(c) along a line A-A′ in some embodiments of the present invention.

FIG. 4, which includes FIGS. 4(a) and 4(b), illustrates the pin-out patterns of a processor (FIG. 4(a)) and a memory assembly (FIG. 4(b)) with processor-specific package pin-out according to embodiments of the present invention.

### DETAILED DESCRIPTION

The invention can be implemented in numerous ways, including as a process; an apparatus; a system; and/or a composition of matter. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

According to embodiments of the present invention, a memory assembly has a package pin-out that is a mirror-image of the pin-out of the memory interface of a processor. In this manner, the processor can be mounted on one side of a printed circuit board and the memory assembly can be mounted to the opposite side of the printed circuit board in direct alignment with the memory interface pin-out of the processor. The memory assembly pins or leads are connected to the processor device memory interface pins or leads using through-vias formed in the printed circuit board. The memory assembly thus configured has the advantage of simplifying the printed circuit board layout by eliminating traces and multiple vias that may be necessary to connect external memory to a processor. More importantly, the memory assembly of the present invention with processor-specific package pin-out ensures that the connections of the address lines and data lines between the memory chips in the memory assembly and the processor are shortened and balanced. Furthermore, using the memory assembly of the present invention can lead to a reduction in the number of layers required for the printed circuit board as compared to the use of discrete memory devices. Lastly, using the memory assembly of the present invention can also eliminate the need for termination resistors thus lowering the materials and manufacturing costs for a processor-memory circuit module.

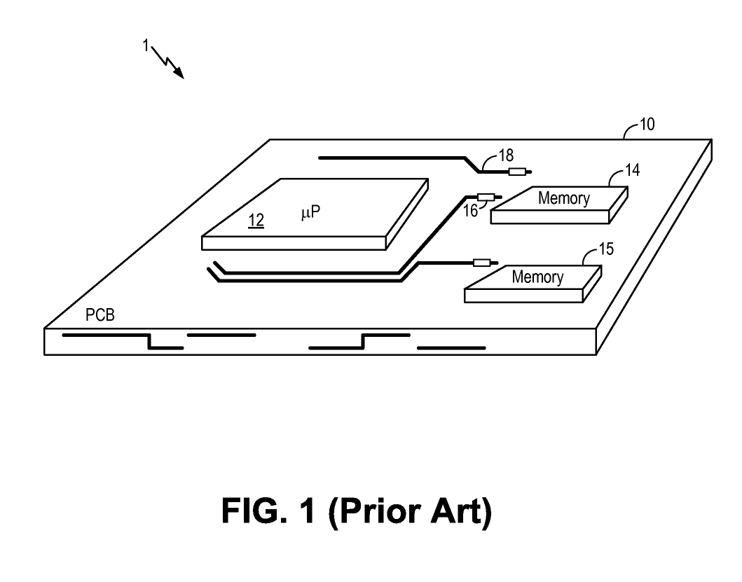

FIG. 1 is a perspective view of a conventional circuit module including a processor connected to one or more discrete memory devices. A circuit module 1 is formed on a printed circuit (PC) board 10 which is typically a multi-layer PC board. The circuit module 1 includes a processor 12 connected to discrete memory devices 14 and 15. Discrete memory device 14 or 15 refers to an integrated circuit or a packaged semiconductor device containing a memory semiconductor chip (or an integrated circuit die). Discrete memory devices 14 and 15 typically have a standard package pin-out, such as the JEDEC standard pin-out. The discrete memory devices 14 and 15 are connected to the processor 12 using conductive traces 18 formed on or in the multi-layer PC board 10. Conductive traces 18 between adjacent layers are typically connected through vias. In order to ensure signal integrity between the processor and the discrete memory devices, especially when the speed of the processors becomes faster, the routing connections between the discrete memory devices 14, 15 and the processor 12 must be well balanced. Furthermore, to ensure signal integrity, termination resistance 16 is often required at the ends of the conductive traces 18 to prevent signal reflection.

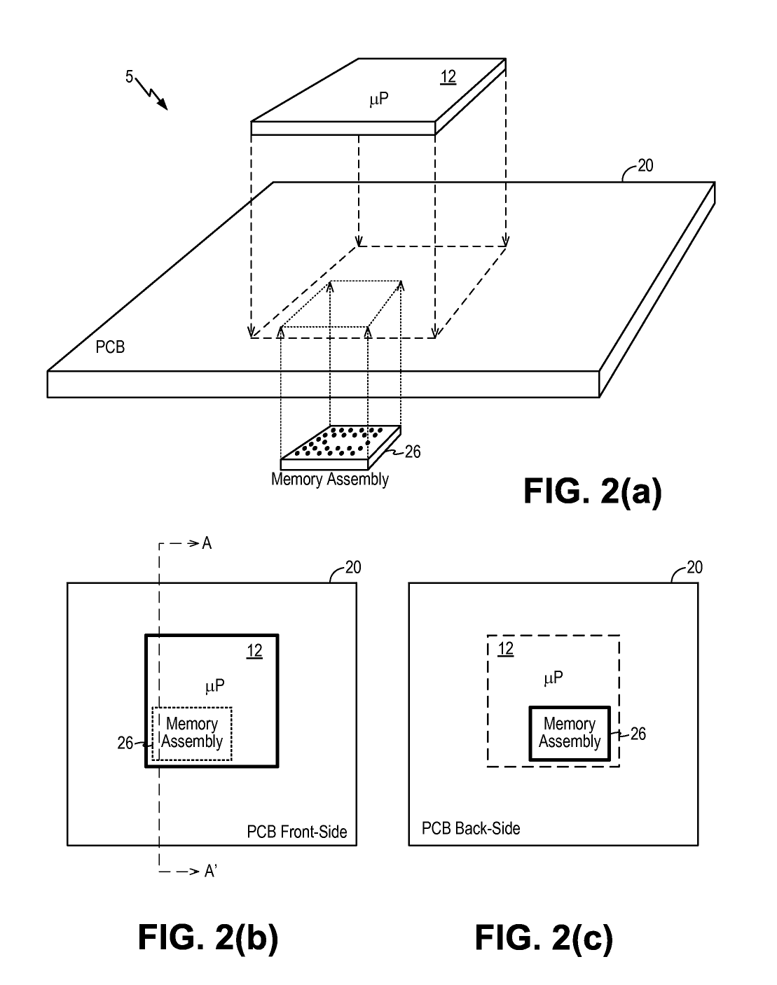

FIG. 2(a) illustrates a circuit module constructed using a memory assembly having processor-specific package pin-out according to one embodiment of the present invention. FIGS. 2(b) and 2(c) are front-side view and back-side view, respectively, of the circuit module of FIG. 2(a). Referring to FIGS. 2(a) to 2(c), a circuit module 5 is formed on a printed circuit (PC) board 20. In some embodiments, the circuit module 5 is a multi-layer PC board. The circuit module 5 may include various components that are mounted on one side (e.g., the front side) or on both sides (e.g., the front and back sides) of the PC board 20. In some applications, components are mounted on both sides of the PC board to minimize the size of the PC board 20.

The circuit module 5 includes a processor 12 mounted on a first side, such as the front side, of the PC board 20. The processor 20 can be a microprocessor, a central processing unit, or a graphic processor. The operation of the processor 12 is typically supported by an external memory. Therefore, it is often necessary to couple an external memory to the processor 12 on the same PC board 20. In the present embodiment, the circuit module 5 includes a memory assembly 26 connected to the processor 12 to support the operation of the processor. In embodiments of the present invention, memory assembly 26 may be formed using SRAM, DRAM, and/or Flash memory devices. In one embodiment, memory assembly 26 includes a single memory semiconductor chip. In an alternate embodiment, memory assembly 26 includes two or more memory semiconductor chips (or an integrated circuit die). The two or more memory semiconductor chips may be the same type of memory devices, such as all SRAM chips, or they may be different types of memory devices, such as an SRAM and a DRAM. The specific types of memory and the number of memory chips incorporated in the memory assembly 26 depends on the application of the processor and the circuit module in which the processor is incorporated.

The processor 12 is typically a packaged semiconductor device or an integrated circuit. The processor 12 has a given package pin-out to interface with components of the circuit module 5, including the memory assembly 26. The package pin-out defines the function of each package lead of the processor 12. In the present embodiment, the processor 12 is housed in a surface-mount packaging. In some embodiments, the processor 12 is packaged using a surface-mount packaging, such as a grid array package, including a ball grid array package or a land grid array package. In a ball or land grid array package, the package leads are arranged in a two-dimensional array on the bottom-side of the package. The grid array package is mounted on the PC board so that the two-dimensional array of package leads are connected to corresponding conductive pads on the PC board to enable electrical connection to be made between leads of the processor integrated circuit and other components on the PC board. A processor that interfaces with an external memory or a supporting memory includes package leads that are assigned to interface with the memory. The memory interface package leads may include address lines, data lines and control signals, such as chip enable and output enable signals. In the present description, a memory interface pin-out refers to the positions or assignment of package leads of a processor for interfacing with a supporting memory. Accordingly, a processor that interfaces with an external memory will have a given memory interface pin-out defining the package leads that are to be connected to the supporting memory device.

In embodiments of the present invention, the memory assembly 26 is configured to have a processor-specific package pin-out to allow the memory assembly to be mounted on the opposite side of the PC board 20 from the processor and in direct alignment to the processor 12. More specifically, in embodiments of the present invention, memory assembly 26 is formed using surface-mount packaging, such as a ball or land grid array package. Memory assembly 26 is configured to have a package pin-out that is a mirror-image of a corresponding memory interface pin-out of the processor 12. For instance, the processor 12 may have a first group of package leads forming the memory interface pin-out for interfacing with a supporting memory. Memory assembly 26 is provided with a processor-specific package pin-out that corresponds to a mirror image of the memory interface pin-out of the processor 12. As thus configured, the memory assembly 26 can be mounted on the opposite side of the PC board 20 directly under the processor 12 and aligned with the memory interface pin-out. In some embodiment, the memory interface package leads of the processor 12 are electrically connected to the package leads of the memory assembly 26 using vertical through-vias formed in the PC board 20.

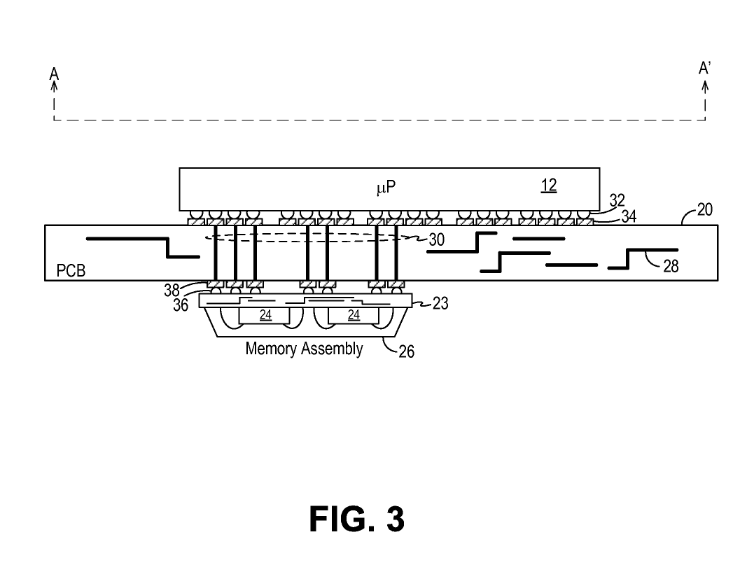

FIG. 3 is a cross-sectional view of the circuit module of FIGS. 2(a)-(c) along a line A-A′ in some embodiments of the present invention. Referring to FIG. 3, the processor 12 is formed on a first side (e.g. front side) of the printed circuit board 20. In the present illustration, the processor 12 is packaged as a ball grid array. When the processor 12 is mounted on the printed circuit board 20, the ball leads 32 of the processor 12 are connected to conductive pads 34 formed on the PC board 20. The conductive pads 34 of the PC board 20 are connected to conductive traces formed on or in the PC board to interconnect the processor to components formed on the PC board.

In embodiments of the present invention, the memory assembly 26 with processor-specific package pin-out is mounted to a second side, opposite to the first side, of the printed circuit board 20. In the present illustration, the memory assembly 26 is packaged in a ball grid array package. When the memory assembly 26 is mounted on the printed circuit board 20, the ball leads 36 of the memory assembly 26 are connected to conductive pads 38 formed on the PC board 20. More specifically, the memory assembly 26 is positioned such that the leads of the memory assembly are in direct alignment with the corresponding memory interface leads of the processor 12. In this manner, the memory assembly 26 can be connected to the processor 12 using through-vias 30 formed in the PC board 20. In embodiments of the present invention, through-vias 30 refer to vias formed in the PC board that connects conductive pads formed on one side of the PC board directly to the opposite side of the PC board. In some embodiments, a through-via is perpendicular to the surface of the PC board and represents the shortest distance through the PC board between a pair of vertically aligned conductive pads formed on opposite sides of the PC board. In the present embodiment, through-vias 30 are perpendicular to the surface of the PC board 20. In other embodiments, the through-vias 30 may be parallel slanted conductive vias. The exact structure of through-vias 30 is not critical to the practice of the present invention. Through-vias 30 are typically formed using the shortest distance between a pair of vertically aligned conductive pads on opposite sides of the PC board.

In embodiments of the present invention, memory assembly 26 may include one or more memory semiconductor chips 24. The number of memory semiconductor chips that may be included in a memory assembly depends on the requirement or configuration of the processor 12. For example, a 32-bit processor may use two 16-bit memory devices. In the present embodiment, the memory assembly 26 includes two memory semiconductor chips 24 formed on a package substrate 23, sometimes referred to as an interposer. The leads of the semiconductor chips 24 are connected to the package substrate 23, such as through wire bonding as shown in FIG. 3. In other embodiments, the memory semiconductor chips 24 can be connected to the package substrate 23 through other interconnection methods, such as tape-automated-bonding (TAB) or direct attach flip-chip bonding. Furthermore, in the present illustration, the memory semiconductor chips 24 are positioned side-by-side on the package substrate 23. In other embodiments, the memory semiconductor chips 24 may be configured in a stacked formation. The memory semiconductor chips 24 are typically encapsulated, such as in a mold compound.

The package substrate 23 (or interposer) connects the leads of the memory semiconductor chips 24 to the package leads, such as ball leads 36 of the memory assembly. In this manner, the package substrate connects signals of the memory semiconductor chips 24 to the ball leads 36 so that the signals can be accessed outside of the memory assembly 26. The package substrate 23 is configured so that the ball leads 36 have a processor-specific package pin-out. In this manner, regardless of the number or types of memory semiconductor chips formed thereon, the package substrate 23 provides the processor-specific package pin-out to enable the memory assembly 26 to interface directly with an external system, such as the processor 12. In some embodiments, the memory assembly 26 includes memory semiconductor chips of the same memory type. That is, the memory semiconductor chips 24 may be SRAM, DRAM, or Flash memory devices. In other embodiments, the memory assembly 26 includes memory semiconductor chips of different memory types. That is, the memory semiconductor chips 24 may include a SRAM device, a DRAM device, and/or a Flash memory device.

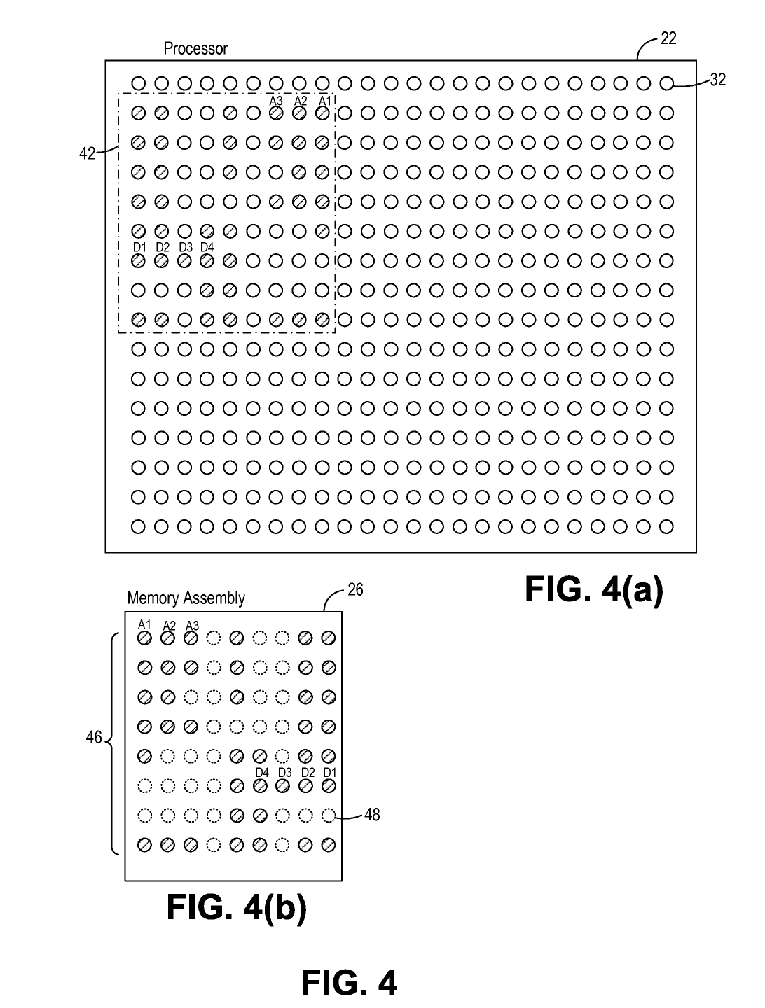

FIG. 4, which includes FIGS. 4(a) and 4(b), illustrates the pin-out patterns of a processor (FIG. 4(a)) and a memory assembly (FIG. 4(b)) with processor-specific package pin-out according to embodiments of the present invention. Referring to FIG. 4, in the present embodiment, the processor 12 and the memory assembly 26 are formed using surface-mount packaging and more specifically, are formed using ball grid array packages. Accordingly, each of the processor and the memory assembly includes a two-dimensional array of package leads formed on one side, usually the bottom side, of the surface-mount package. In the present illustration, the packages are shown with a full array of ball leads. It is understood that a grid array package may be formed using less than the full array of ball leads. The use of a full array of ball leads in FIG. 4 is illustrative only.

The processor 12 includes a set of memory interface package leads (shaded leads in area 42) that are assigned to interface with a supporting memory. The memory assembly 26 with processor-specific package pin-out is formed with a pin-out pattern or package lead pattern that is a mirror-image of the memory interface package leads in area 42. More specifically, the memory assembly 26 includes package leads 46 (shaded leads) that are configured to correspond to the memory interface package leads of the processor 12. For example, address pins A1 to A3 and data pins D1 to D4 on the processor correspond to the same address pin A1 to A3 and data pins D1 to D4 on the memory assembly but in a mirror image arrangement. The package leads 46 of memory assembly 26 are arranged to have a mirror image of the memory interface package leads 42 so that the memory assembly 26 can be coupled on the opposite side of the PC board in direct alignment with the processor 12. In embodiments of the present invention, the memory assembly 26 may be formed using only the set of leads 46 that corresponds to the memory interface package leads 42 of the processor. Other leads (dotted circle) of the two-dimensional array may be omitted. In some embodiments, the memory assembly 26 includes one or more dummy leads 48 for structural support and ease of manufacturing. The dummy leads 48 can be left electrically floating or electrically grounded.

The memory assembly having processor-specific package pin-out realizes many advantages when applied in circuit modules. First, the memory assembly of the present invention ensures that the connections of the address lines and data lines between the memory assembly and the processor are well balanced. That is, all the address lines have equal length and equal number of connecting vias. Furthermore, the memory assembly of the present invention ensures the shortest connection between the processor leads and the memory assembly leads. As thus configured, the memory assembly supports high speed interface to the processor without degrading signal integrity.

Second, the memory assembly having processor-specific package pin-out of the present invention enables mounting of the memory assembly directly under the processor to reduce the space required to implement the processor and the supporting memory. Accordingly, the size of the PC board required to implement the circuit module can be reduced, thereby reducing manufacturing cost for the circuit module.

Third, when a memory assembly having processor-specific package pin-out is used, the circuit module 5 can be constructed using a printed circuit board with reduced number of conductive layers. In particularly, when the memory assembly is directly connected to the processor 12 using through-vias, the number of conductive traces needed to interconnect the memory assembly to the processor reduces significantly. A printed circuit board with reduced number of conductive layers can be used, thereby reducing the cost of the PC board and the associated cost for the circuit module. In one embodiment, a circuit module using a memory assembly having processor-specific package pin-out may be formed using a printed circuit board with 4-6 layers whereas a circuit module using conventional discrete memory devices may require a printed circuit board with 8-12 conductive layers, depending on the complexity of the complete application circuit.

Fourth, when the amount of conductive traces is reduced, electromagnetic interference (EMI) from the circuit module is reduced and shielding cost associated with the circuit module may also be reduced.

Lastly, the use of the memory assembly eliminates the need for termination resistance as the length of the conductive traces that connect the processor and the memory assembly is reduced to a shortness such that the needs for termination resistance is obviated. Accordingly, a circuit module formed using the memory assembly of the present invention does not require the use of termination resistance at the ends of the conductive traces.

In some embodiments, the memory assembly with processor-specific package pin-out can be formed using a single memory semiconductor chip (or an integrated circuit die). In other embodiments, the memory assembly with processor-specific package pin-out can be formed using a multi-chip module with multiple memory semiconductor chips housed in a single package. For example, a memory assembly may have two to four memory semiconductor chips packaged together into a single package. The exact configuration of the memory assembly is not critical to the practice of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A memory assembly, comprising:
one or more memory semiconductor chips housed in a surface mount semiconductor package, the one or more memory semiconductor chips being formed on a package substrate, the package substrate comprising a two-dimensional array of package leads for connecting signals of the one or more memory semiconductor chips to an external system, wherein the two-dimensional array of package leads of the memory assembly has a package pin-out being a mirror image of a memory interface pin-out of a processor.

2. The memory assembly of claim 1, wherein the package pin-out of the memory assembly comprises a pattern of package leads associated with address lines, data lines and control signals of the one or more memory semiconductor chips, wherein the pattern of the package leads of the memory assembly is a mirror image of a pattern of the package leads associated with the same address lines, data lines and control signals on the processor.

3. The memory assembly of claim 1, wherein the surface mount semiconductor package comprises a grid array package.

4. The memory assembly of claim 3, wherein the surface mount semiconductor package comprises a ball grid array package or a land grid array package.

5. The memory assembly of claim 1, wherein each of the one or more memory semiconductor chips of the memory assembly comprises a SRAM, a DRAM or a Flash memory device.

6. A circuit module, comprising:
a printed circuit board;
a processor in a first surface mount semiconductor package mounted on a first side of the printed circuit board, the processor including a first set of package leads for interfacing with an external memory, the first set of package leads being arranged in a pattern to form a memory interface pin-out, the first set of package leads being electrically coupled to a first set of conductive pads formed on the first side of the printed circuit board; and
a memory assembly in a second surface mount semiconductor package mounted on a second side of the printed circuit board, the second side being opposite the first side, the memory assembly comprising one or more memory semiconductor chips being formed on a package substrate, the package substrate comprising an array of package leads for connecting signals of the one or more memory semiconductor chips to an external system, the array of package leads being electrically coupled to a second set of conductive pads formed on the second side of the printed circuit board, the array of package leads being arranged in a pattern to form a memory assembly pin-out,
wherein the memory assembly pin-out is a mirror image of the memory interface pin-out of the processor and the memory assembly is positioned in direct alignment with the memory interface pin-out of the processor, and wherein each conductive pad in the first set of conductive pads is electrically connected to a corresponding conductive pad in the second set of conductive pads through a conductive connection formed in the printed circuit board.

7. The circuit module of claim 6, wherein each conductive pad in the first set of conductive pads is electrically connected to the corresponding conductive pad in the second set of conductive pads by a through-via formed in the printed circuit board.

8. The circuit module of claim 6, wherein each conductive pad in the first set of conductive pads is vertically aligned to the corresponding conductive pad in the second set of conductive pads.

9. The circuit module of claim 6, wherein the memory assembly pin-out comprises a pattern of package leads associated with address lines, data lines and control signals of the one or more memory semiconductor chips, wherein the pattern of the package leads of the memory assembly is a mirror image of a pattern of the package leads associated with the same address lines, data lines and control signals on the processor.

10. The circuit module of claim 6, wherein the first and second surface mount semiconductor packages each comprises a grid array package.

11. The circuit module of claim 10, wherein the first and second surface mount semiconductor packages each comprises a ball grid array package or a land grid array package.

12. The circuit module of claim 6, wherein each of the one or more memory semiconductor chips of the memory assembly comprises a SRAM, a DRAM or a Flash memory device.

13. The circuit module of claim 6, wherein the first set of package leads of the processor are connected to corresponding package leads of the memory assembly without termination resistance.
